(19) United States
(12) Patent Application Publication
(10) Pub. No.: US 2009/0043644 A1
(43) Pub. Date: Feb. 12, 2009

(54) UNIVERSAL TRANSACTION MANAGER AGENT, SYSTEMS AND METHODS

(76) Inventor: Michael A. Wilkman, Danville, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/240,946

(22) Filed: Sep. 29, 2008

Related U.S. Application Data
(63) Continuation of application No. 09/909,194, filed on Jul. 19, 2001.
(60) Provisional application No. 60/220,637, filed on Jul. 25, 2000.

(51) Int. Cl. G06Q 30/00

(52) U.S. Cl. 705/10; 705/14

(57) ABSTRACT

The present invention relates generally to systems and methods for providing transaction control for purchasing decisions that involve the use of credits, debits, loyalty points, affinity points, promotions, or currency transfers. The present invention provides a common forum where merchants desiring to target consumers prior to or at the time of purchase are matched with customers who desire information, goods, or services related to the merchant. In general, the matching and coordinating of the credit accounts, debit accounts, loyalty (points) programs, affinity (points) programs, promotions, and currency exchanges are performed such that consumers and businesses may obtain the greatest financial, promotional, or desired benefit on purchases of goods and services. Further, merchants may present promotional opportunities to consumers or businesses prior to, at the time of or after transacting the payment of goods or services.

### PRIORITY INFORMATION

This application relates to and claims priority from Provisional Application No. 60/220,637 filed Jul. 25, 2000, which is hereby incorporated by reference.

### FIELD OF THE INVENTION

The present invention relates generally to electronic commerce processing, and in particular to systems and methods for providing custom transaction control for purchasing decisions which involve credits, debits, loyalty points, affinity points, promotions, and/or currency transfers.

### BACKGROUND

With the increasing popularity of the use of credit accounts, debit accounts, loyalty (points) programs, affinity (points) programs, electronic promotions, and currency exchanges by individuals making purchasing decisions, purchasers and customers often desire that each purchasing decision is calculated to provide the maximum financial or targeted benefit for the purchaser. Often, the actual cost of purchasing goods or services may be greatly enhanced by knowing the combined benefit of all the accounts, programs, and promotions that relate to the actual purchase. Additionally, merchants typically welcome the opportunity to interact with purchasers prior to the payment process.

One common problem, however, is that the great number of accounts and programs available to consumers, who are making purchasing decisions, may not be remembered or understood at the time of purchase. Further, many of the accounts, programs, and promotions are being updated constantly making it impossible for consumers to remember all of the possibilities and combinations that may affect the purchase. Additionally, with the rapid growth of a variety of devices for executing purchases, including personal computers, cell phones, smart cards, Palm devices, kiosks, conventional telephones, as well as conventional credit cards, consumers may not locate purchasing incentives and promotional opportunities which might reduce or enhance the actual purchase. Even if consumers or businesses are able to find a set of accounts, programs, and/or promotions which provide the maximum desired benefit at the time of purchase, it is often time consuming for the consumer/purchaser to peruse all of the opportunities which might enhance the final purchase decision.

Furthermore, even if the consumer or purchaser finds one or more merchants that provide an interest rate, loyalty points, or promotions which enhance the final purchase price, it is common that the opportunities have expired or do not apply to the consumer's needs and thereby fail to apply to the particular date, product, and/or place of the desired goods or services. Finally, merchants desiring to target purchasers with opportunities and incentives, at or prior to the time of purchase, are in need of a common forum to securely present, distribute, and transact their purchasing incentives using a broad range of devices which may be utilized by purchasers to initiate the transaction.

### SUMMARY OF THE INVENTION

The present invention relates generally to matching and coordinating the use of credit accounts, debit accounts, loyalty (points) programs, affinity (points) programs, promotions, and currency exchanges to enhance the purchase transaction of consumers and businesses. The enhancements may include financial, promotional, or other benefits for various purchases of goods and services thereby enabling merchants to target their incentives to consumers and businesses prior to or at the time of the purchase transactions.

For summarizing the invention, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

### BRIEF DESCRIPTION OF THE DRAWINGS

These and other features and advantages of the invention will now be described with reference to the drawings and of certain preferred embodiments, which are intended to illustrate and not limit the invention.

FIG. 1 illustrates a high-level block diagram of one embodiment of the present invention.

FIG. 2 illustrates a flow diagram of one embodiment of registering a merchant.

FIG. 3 illustrates a flow diagram of one embodiment of collecting promotions from a merchant.

FIG. 4 illustrates a flow diagram of one embodiment of calculating the merchant's bill.

FIG. 5 illustrates a flow diagram of one embodiment of registering a user.

FIG. 6 illustrates a flow diagram of one embodiment of accepting a user request.

FIG. 7 illustrates a flow diagram of one embodiment of querying the user to determine the user's interests.

FIG. 8 illustrates an example of web page which includes one view of a sample universal transaction manager.

FIG. 9 illustrates an example set of differential filters of the universal transaction manager as seen on a sample display.

FIG. 10 illustrates an example set of differential filters of the universal transaction manager as seen on a sample display.

FIG. 11 illustrates an example display from a sample universal transaction manager.

FIG. 12 illustrates a block diagram of one embodiment of the universal transaction manager acting as an independent agent.

### DETAILED DESCRIPTION OF PREFERRED EMBODIMENTS

Systems and methods which represent one embodiment and example application of the invention will now be described with reference to the drawings. Variations to the systems and methods which represent some other embodiments will also be described. In one embodiment, the systems and methods are used to provide remote users with a customized universal transaction manager.

For purposes of illustration, one embodiment will be described in the context of the Internet. The inventors contemplate that the present invention is not limited by the type of communications medium used. Other types of communications mediums may be used, such as, for example, satellite broadcasts, local area networks, wide area networks, wireless networks, telephone networks, and so forth. Furthermore, in other embodiments, the universal transaction manager systems and methods may be implemented as a single module, as a collection of modules, and/or implemented in conjunction with a variety of other modules and the like. Moreover, the specific implementations described herein are set forth in order to illustrate, but not to limit, the invention. The scope of the invention is defined by the claims.

These and other features will now be described with reference to the drawings summarized above. The drawings and the associated descriptions are provided to illustrate embodiments of the invention, and not to limit the scope of the invention. Throughout the drawings, reference numbers may be re-used to indicate correspondence between referenced elements. In addition, the first digit of each reference number generally indicates the figure in which the element first appears.

### I. Overview

Within the realm of electronic commerce, it is common for customers to purchase goods and services from a variety of remotely accessible merchants. As part of the electronic commerce experience, customers attempt to maximize or enhance their purchasing power by finding programs that provide an additional benefit to the customer. These programs may include merchant-sponsored programs such as discounts, coupons, and free goods/services. In addition, the programs may include programs sponsored by third parties such as, for example, sweepstakes, interactive games, credit card rebates, charitable donations, and so forth. These third-parties may include, for example, payment entities (e.g., credit card companies, debit card companies, on-line payment companies), as well as charitable entities, manufacturers, advertisers, and so forth.

To assist the customers with finding programs that relate to the customer's interests, the universal transaction manager system provides the customer with a universal transaction manager that the customer may remotely access and control. The customer may configure the universal transaction manager to store general information about the customer such as name, address, phone number, and so forth. In addition, the universal transaction manager may include the customer's account information, such as credit card account information, debit card account information, on-line payment information (e.g., Paypal information), bank account information, and so forth. The customer may set up rules that govern which accounts will be used to pay for various transactions based upon criteria, such as, for example, date of transaction, amount of transaction, merchant, and so forth. For example, a customer may elect to use a specific credit card for all on-line ticket purchases because that credit card offers free flight insurance.

The customer may also configure the universal transaction manager to include information about the customer's preferences, interest, hobbies, upcoming travel plans, favorite merchants, and so forth. The customer may also control the information that the universal transaction manager may share with merchants and other third parties. For example, the customer may configure the universal transaction manager to share the customer's zip code with all merchants and third parties, but restrict the customer's gender or purchasing history to those merchants and third parties that have a privacy rating of X, where X is a predetermined threshold. Thus, by using various rules, the customer is able to control the customer's information by restricting outside access to his or her information. The customer may also set rules for performing automatic transactions, such as automatic purchases or online bidding. The customer may also be presented with tools to override and/or to change the rules.

The customer may also use the universal transaction manager to view and peruse opportunities and programs offered by merchants and other third parties. When a customer logs on and views the customer's universal transaction manager, the customer may be presented with a list of promotions from various third parties to which the customer has made information available. For example, if a customer has elected to share the customer's zip code and interest in German cars with all third parties, the customer may be presented with promotions that include a downloadable coupon for a restaurant in the customer's zip code, a link to “BMW Films,” and an invitation to “test drive” the new Audi. The customer may also be presented with an account section wherein the user may add, change, or delete his or her information and/or rules.

As the customer selects various programs or promotions presented by the customer's universal transaction manager, the customer may be rewarded in various ways, such as being credited monetary compensation, airline miles, loyalty points, free merchandise, and so forth. Further, as the customer accesses the universal transaction manager and the presented programs or promotions, the universal transaction manager system may track the customer's activity including, visited web pages, click throughs, shopping cart selections, purchases, questionnaires submitted, and so forth. As noted above, in various embodiments, the user may set rules for which merchants and third parties, if any, may access this information.

The customer's universal transaction manager may then share information approved by the customer with merchants and other third parties that interact with the universal transaction manager system. Merchants may create accounts that provide the universal transaction manager with information about their goods, services, promotions, and so forth. In addition, merchants may also submit information that will be submitted to customers that match certain criteria. The merchants may also include rules that govern how customers may be “rewarded” for various activity.

The universal transaction system may then match merchant and third party information with customer information available from the customer's universal transaction manager and provide customers with custom-selected promotions and programs.

Various embodiments of the systems and methods of the present invention may overcome one or more of the difficulties discussed above by providing a common forum wherein consumers and businesses may match and coordinate the use of credit accounts, debit accounts, loyalty (points) programs, affinity (points) programs, promotions, and currency exchanges so that consumers and businesses obtain an increased benefit on purchases of goods and services. In addition, merchants may advertise their goods and services such that consumers may find promotions that apply to the goods and services they seek, enabling merchants to target certain promotions to a consumer who has indicated an interest in the targeted area.

As used herein, the term “universal transaction manager” refers to an agent that may, but need not necessarily, include various types of differential filters and promotions implemented using hardware and/or software. Furthermore, while the systems discussed are implemented on an Internet web site, it is recognized that the systems may be implemented using standalone software and/or encoded into hardware, and may be embedded in a variety of systems, such as, for example, a cellular phone, a portable computing device, a computer, a smart card, a wireless device, and so forth. In addition, the systems may be accessed using a variety of communication techniques, such as, for example, an Internet connection, a telephone line, customized email, and so forth.

For purposes of summarizing the invention, certain aspects, advantages, and novel features of the invention are described herein. It is to be understood that not necessarily all such advantages may be achieved in accordance with any particular embodiment of the invention. The invention may be embodied or carried out in a manner that achieves one advantage or group of advantages as taught herein without necessarily achieving other advantages as may be taught or suggested herein.

### II. Universal Transaction Manager System

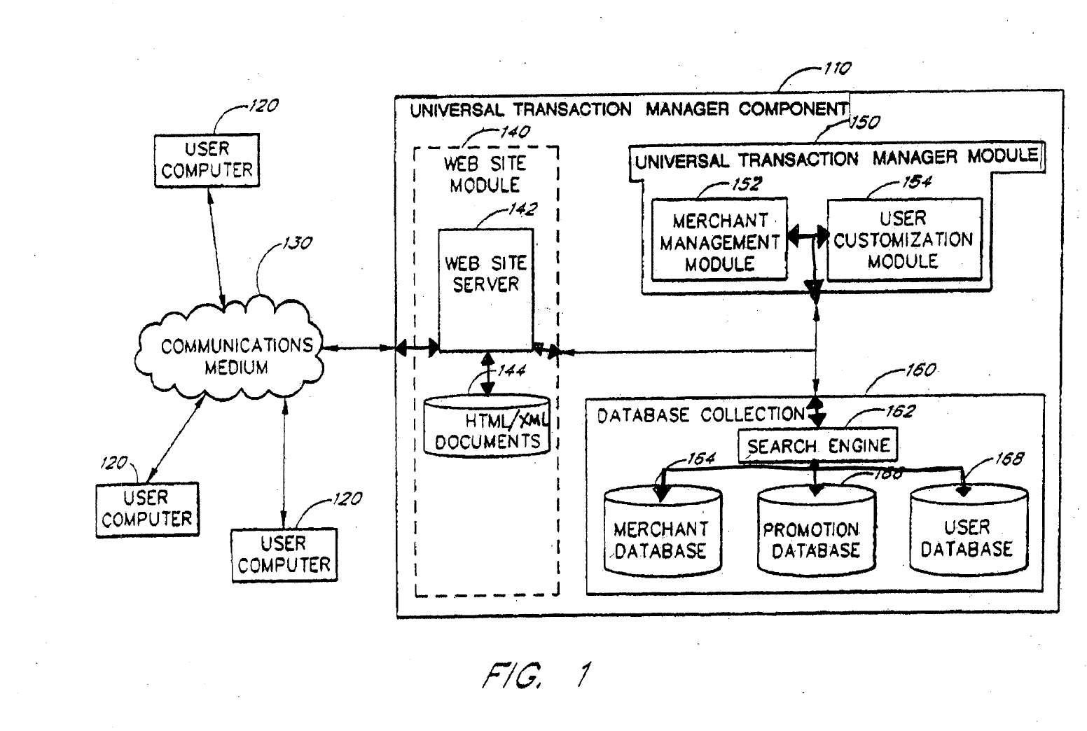

An overview of one embodiment of a universal transaction manager system is shown in FIG. 1. In the exemplary system, a universal transaction manager component 110 communicates with a user computer 120 over a communications medium 130.

As used herein, the words module and component, whether in upper or lower case letters, refer to logic embodied in hardware or firmware, or to a collection of software instructions, possibly having entry and exit points, written in a programming language, such as, for example, C++. A software module or component may be compiled and linked into an executable program, or installed in a dynamic link library, or may be written in an interpretive language such as BASIC. It will be appreciated that software modules and components may be callable from other modules or components or from themselves, and/or may be invoked in response to detected events or interrupts. Software instructions may be embedded in firmware, such as an EPROM. It will be further appreciated that hardware modules may be comprised of programmable units, such as programmable gate arrays or processors. The modules and components described herein are preferable implemented as software modules, but may be implemented in hardware or firmware.

A. Universal Transaction Manager Component

In one embodiment, the universal transaction manager component 110 tracks and manages credit card accounts as requested by the user. In addition, the universal transaction manager component may track and manage debit card accounts, loyalty point and affinity point accounts, currency transfers, as well as other types of user accounts. The universal transaction manager component 110 may also manage merchants and their promotions. In addition, the universal transaction manager component 110 may provide users with customer universal transaction managers at their request.

In one embodiment, the universal transaction manager component 110 includes a web site module 140, a universal transaction manager module 150, and a database collection 160.

The universal transaction manager component 110 may interact with other modules, components, interfaces, and/or protocols (not shown). For example, the universal transaction manager component 110 may communicate with a user's date book software to order synchronize with other transaction manager events. This synchronization may be one way or two way synchronization wherein the universal transaction manager module 150 only receives events, only sends events, or receives and sends events. In another example, the universal transaction manager may synchronize with a cellular phone to allow the user to receive phone calls about a variety of promotions and/or to automatically call merchants to obtain more information about the promotions. In another example, the universal transaction manager may be configured to acquire discounts in a certain location (e.g., zip code, city, state, etc.). The user may activate a GPS (global positioning) interface for the universal transaction manager to send opportunities or promotions which match user interests for users in a specific location. By restricting selections, the universal transaction manager may also become a filter to assist with preventing the invasion of the user's privacy by unwanted advertisers.

1. Web Site Module

The web site module 140 includes a web site server application (“web server”) 142 which processes user requests received from the user computers 120 via the communications medium 130. The user requests may include, for example, requests to add to or update the customer's information and/or rules, requests to view a universal transaction manager, requests to search on-line for promotions, and/or requests to update merchant billing information. In one embodiment, the web server 142 accesses a database of HTML (Hypertext Markup Language) or XML content 144 which includes, among other things, web pages for performing various types of functions. In other embodiments, the database of HTML or XML 144 may also include other information such as server and client side scripts.

In one embodiment, the web server 142 includes web server software (not shown), such as, for example, Netscape's Internet Server software, Microsoft's Internet Server software, or the like. Such web server software may be configured to process messages from the user computers 120 and to store and access information from the universal transaction manager component 110.

A wide variety of web pages and/or other electronic documents may be used; thus, the sample web pages and displays are meant only to illustrate specific embodiments of the invention. Furthermore, the invention may be implemented within a web site (or group of affiliated web sites), an online services network, an interactive television system, or a system that supports interactive browsing by voice (e.g., a voice XML based system). Further, the invention may be embodied within systems in which purchases are made at point-of-sale terminals within physical stores.

2. Universal Transaction Manager Module

In one embodiment, the universal transaction manager module 150 interacts with the database collection 160 to search and perform queries on the database collection 160. For example, universal transaction manager module 150 may communicate with the user database 168 to obtain information regarding the user's interests, with the promotion database to select promotions that relate to the user's interest, and/or with the merchant database to obtain information about the merchants.

In one embodiment, the universal transaction manager module 150 interacts with the web site module 140 to receive and provide promotion information, user information, and merchant information to the user computer 120.

The exemplary universal transaction manager module 150 includes a merchant management module 152 and a user customization module 154.

a. Merchant Management Module

The merchant management module 152 collects and manages information about the merchants that wish to promote goods or services in the system. The merchant management module 152 may also enable merchants to submit promotions for display on a transaction manager or to send direct targeted advertising to consumers who have indicated an interest in the manager's goods and/or services. In addition, the merchant management module 152 may track various activity, such as, for example, when a merchant's promotions are displayed, sent directly to the user, and/or accessed by the user. In addition, merchants may be permitted to view user transaction managers and requests. For example, a merchant may enter the web site, and view the user's transaction manager to decide whether to add a promotion to the database, or whether to add a promotion to a specific user's universal transaction manager. In one embodiment, the merchant management module 152 communicates with the database collection 160 to enable a merchant to search user transaction managers for specific requests. Merchants may then provide a related promotion directly to a requesting user or to the customer's universal transaction manager.

In one embodiment, the merchant may search user transaction managers to determine the user's credit requirements based on a purchase. For example, a merchant may determine how much credit is required for a purchase, what users may be willing to pay for the credit card usage, whether there are auction opportunities such that the merchant or user may bid for a promotion rate, as well as what action may be taken to reduce or maximize the merchant's ability to sell a credit relationship to the user. The merchants may be given search tools as well as standard and/or customized reports that access user information.

In one embodiment, merchants may be given the opportunity to bid for the credit relationship with the user at the time of or prior to the purchase transaction or in an open bidding process to develop a merchant credit relationship with the user.

It is recognized that the term “merchant” may include a variety of third parties that wish to attract customers including retailers, wholesalers, service providers, manufacturers, and so forth. Further, merchants may include third parties that sell, lease, or loan goods or services as well as parties that provide financial services, airline rewards programs, manufacturers, charitable organizations, gaming parties, and so forth.

In one embodiment, the merchant management module 152 includes a merchant registration process, a promotion collection process, and a merchant billing process. For more information on the merchant management module processes, see the section below entitled “Universal Transaction Manager Processes-Merchant Management Module Processes.”

b. User Customization Module

The user customization module collects 154 and manages information about users that wish to view a universal transaction manager, queries the user to determine the user's interests (e.g., the user's target date, place and event), chooses promotions related to the user's designated interests, and displays promotions related to the user's designated interests on the dates indicated. It is recognized that in other embodiments, the user may access coupons without using or having the transaction manager. For example, a user may be sent a targeted promotion via email based upon the user's profile.

The user customization module 154 may also provide the users with a universal transaction manager. For example, a user may enter the web site and request information on an activity or a purchase for a specific date. In one embodiment, the user customization module 154 communicates with the database collection 160 to find and receive user information, promotion information, and/or merchant information.

In one embodiment, the user customization module 154 includes a user registration process and a user request process. For more information on the user customization module processes, see the section below entitled “Universal Transaction Manager Processes-User Customization Module Processes.”

3. Database Collection

In one embodiment, the universal transaction manager system includes a database collection 160 as illustrated in FIG. 1. The exemplary database collection 160 includes a search engine 162 as well as a merchant database 164, a promotion database 166, and a user database 168.

The search engine 162 is a program that searches a database using keywords and/or phrases or other search tools. Many such tools are well known in the art. Thus, the search engine 162 may be used to access information in the database. In one embodiment, the search engine 162 may be implemented in connection with a backend component (not shown) to the database collection 160 that receives database requests via servlets, small programs that run on servers, and sends a corresponding SQL request to the database collection 160. It is recognized that in other embodiments data access may be performed differently, for example, a different backend component may be used or the database collection 160 may be accessed directly.

The merchant database 164 includes information about the merchants that provide promotions for the universal transaction manager system as well as merchants that want to target particular users who have interests relating to the merchant's products and/or services. This information may include data provided by the merchants such as the merchant's name, mailing address, email address, credit card number, login, password, as well as other general information. The merchant database 164 may also include rules set forth by the merchant, such as, for example, rules which regulate how users are compensated and/or when to send a promotion to a user.

The promotion database 166 includes information about the various promotions. In one embodiment, the promotions are related to a merchant in the merchant database 160 such that when a promotion is displayed or accessed, the merchant may be identified and billed. The promotion database 166 may include information such as text to display for the promotion, terms of the promotion, a printable coupon, accompanying audio, graphic, and video files, expiration dates, merchant ID, targeted user, as well as any other information relating to the promotion. For more information on systems and methods for providing customers with a coupon calendar, please refer to U.S. patent application Ser. No. 09/574,627 filed May 19, 2000, which is hereby incorporated by reference.

In one embodiment, promotions may be based on the UPC Code (Uniform Price Code) prior to the purchase transaction. The UPC Code of the product may be input through the user's device by keypad, voice, or scanning receiver and may be used to store the promotion in the promotion database 166. The manufacturer of the subject product or storefront where the product is located could then interface with the user's universal transaction manager to provide additional opportunities to induce a particular purchasing method.

The user database 168 includes information about the users of the universal transaction manager system. This information may include user data such as name, age, sex, address, email address, planned events, login, password, as well as other information. The user database 168 may also include rules the user has put into place to regulate what information, if any, is shared with the merchants, as well as rules relating to automatic transactions. Other information may include information provided by the user as well as information derived from the user's activity, such as, the fact that the user selected multiple purchases relating to golf, thus implying an interest in golf, the user's time spent on the web site, the number of click throughs, and so forth.

The database collection 160 may also include other databases (not shown) for performing various management tasks. For example, the database collection 160 may include an activity database that tracks user and/or merchant activity. In addition, the database collection 160 may include different search mechanisms to acquire information and promotions matching the user's demands from other web sites. For example, the database collection 160 may track whether a user desires to purchase air travel from a particular airline using a particular credit card. The universal transaction manager may receive a query and present the user with information from other web sites regarding promotions, credit cost price points, or loyalty points that relate to the user's query and that are beneficial to the user. In one embodiment, the universal transaction manager acts as an agent of the user.

In connection with the database collection 160, in one embodiment there may be several processes, (not shown), such as ID generators, number generators, statistics generators, session generators, and temporary storage units that work with the database collection 160.

In one embodiment, the database collection 160 is implemented using the relational database, such as the Microsoft® SQL Server, enabling access to the data via the Structured Query Language (“SQL”). SQL is a language standardized by the International Standards Organization for defining, updating, and querying a relational database.

It is recognized that in other embodiments, the database collection 160 may be implemented using different relational databases as well as using one or more other types of databases, such as flat file databases, object oriented databases, hierarchical databases, and so forth. Moreover, while the database collection 160 depicted in FIG. 1 is comprised of several separate databases, it is recognized that in other embodiments, the database collection 160 may contain other databases and/or some of the databases may be combined. In addition, all or part of the database collection 160 may be implemented as a single database with separate tables or as other data structures that are well known in the art such as linked lists, binary trees, and so forth.

B. User Computer

In one embodiment, the user computer 120 is a device which allows users and/or merchants to interact with the communications medium 130 and to access the universal transaction manager component 110. In one embodiment, the user computer 120 is a conventional general purpose computer using one or more microprocessors, such as, for example, as Pentium processor, a Pentium II processor, a Pentium Pro processor, a Pentium IV processor, an xx86 processor, 8051 processor, a MIPS processor, a Power PC processor, or an Alpha processor. In one embodiment, the user computer 120 runs an appropriate operating system such as, for example, Microsoft® Windows® 3.X, Microsoft® Windows® 98, Microsoft Windows® 2000, Microsoft® Windows® NT, Microsoft® Windows® CE, Palm Pilot OS, Apple® MacOS®, Disk Operating System (DOS), UNIX, Linux®, and IBM® OS/2® operating systems. In one embodiment, the user computer 120 is equipped with a conventional modem or other network connectivity such as, for example, Ethernet (IEEE 802.3), Token Ring (IEEE 802.5), Fiber Distributed Datalink Interface (FDDI) or Asynchronous Transfer Mode (ATM). As is conventional, in one embodiment, the operating system includes TCP/IP stack which handles all incoming and outgoing message traffic passed over the communications medium 130.

In other embodiments, the user computer 120 may, for example, be a computer workstation, a local area network of individual computers, an interactive television, an interactive kiosk, a personal digital assistant, an interactive wireless communications device, a kiosk, a handheld computer, a telephone, a cellular phone, a router, a satellite, a smart card, an embedded computing device, or the like which can interact with the communication medium 130. While in such systems, the operating system will differ, they will continue to provide the appropriate communications protocols needed to establish communication links with the communications medium 130.

C. Communications Medium

In one embodiment, the user computers 120 communicate with the universal transaction manager component 110 via a communications medium 130. The communications medium 130 provides a path or link through which information may travel. The communications medium 130 may include one or more paths and may be implemented using physical links, such as, a connecting cable, and/or non-physical links such as channels that send electromagnetic transmissions via satellite, radio, microwave signals, and so forth.

In one embodiment, the communications medium 130 includes the Internet which is a global network of computing devices. The structure of the Internet, which is well known in the art, includes a network of backbone with networks branching from the backbone. These branches, in turn, have networks branching from them, and so on. Routers move information packets between network levels, and then from network to network, until the packet reaches the neighborhood of its destination. From the destination, the destination network's host directs the information packet to the appropriate terminal, or node. A more detailed description of the structure and operation of the Internet is available in many texts, such as, “The Internet Complete Reference,” by Harley Hahn and Rick Stout, published by McGraw-Hill, 1994.

In one embodiment, the Internet routing hubs comprise domain name system (DNS) servers, as is well known in the art. DNS is a Transfer Control Protocol/Internet Protocol (TCP/IP) service that is called upon to translate domain names to and from Internet Protocol (IP) addresses. The routing hubs connect to one or more other routing hubs via high speed communication links.

One popular part of the Internet is the World Wide Web. The World Wide Web includes different computers which store documents capable of displaying graphical, textual information, audio, visual, and other types of information. The computers which provide information on the World Wide Web are typically called “web sites.” A web site is defined by an Internet address which has an associated set of electronic documents. The electronic documents may be identified by a Universal Resource Locator (URL). Generally, an electronic document is a document which organizes the presentation of text, graphical images, audio, video, and so forth.

A wide range of interactive communications mediums 130 may be employed in the present invention. For example, the communications medium 130 may include interactive television networks, telephone networks, wireless data transmission systems, two-way cable systems, customized computer networks, interactive kiosk networks, automatic teller machine networks, and the like.

### III. Universal Transaction Manager Processes

In one embodiment, the universal transaction manager module 150 includes several processes associated with the merchant management module 152 and the user customization module 154.

A. Merchant Management Module Processes

In one embodiment, the merchant management module 152 includes a merchant registration process, a promotion collection process, and a merchant billing process. The merchant management module 152 may include other processes such as, for example, a process for sending updates to merchants, a process for tracking merchant activity, and so forth.

1. Merchant Registration Process

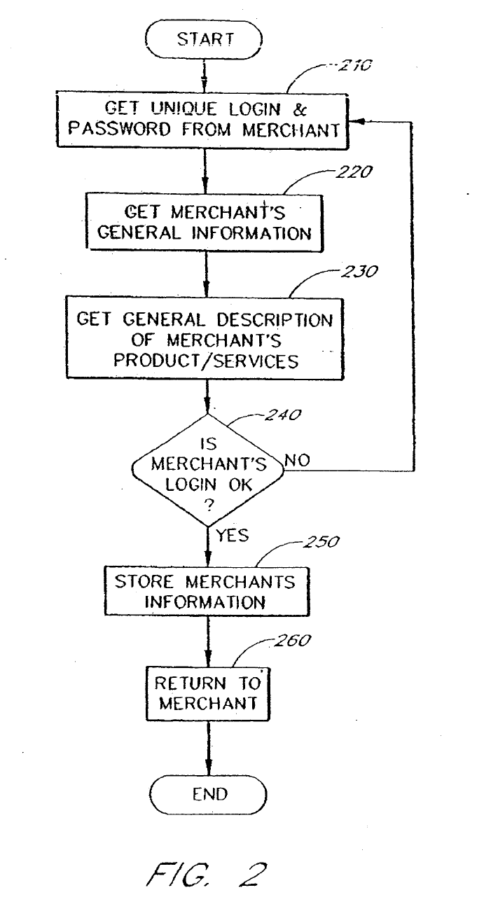

In one embodiment, the merchant registration process collects and manages information about the various merchants that wish to utilize the universal transaction manager. It is understood that the merchant may be able to communicate directly with the universal transaction manager agent through a communications medium 130. In other embodiments, the merchant may communicate with the universal transaction manager using the merchant registration process. The merchant registration process illustrated in FIG. 2 enables merchants to submit their information on-line via a web site.

First, the merchant creates a unique login and secure password (block 210). Next, the merchant submits general information such as its name, mailing address, phone number, email address, credit card number, as well as any other general information (block 220). Third, the merchant may submit a general description of merchant's products, services, opportunities to co-promote with other companies offers and/or promotions (block 230). Then, the merchant registration process verifies that the login is unique (block 240), stores the merchant's information (block 250), and returns to the merchant (block 260).

FIG. 2 illustrates one embodiment of the merchant registration process and other embodiments may be used. For example, the merchant's login may be verified immediately after the login and password are received from the merchant. Further, the merchant may submit general information and/or product/service information at a different time. Also, the merchant's information may be stored as soon as it is received from the merchant. Other variations are also possible.

It is recognized that in other embodiments, the merchant may submit information using other methods such as submission by email, filling out a paper questionnaire, faxing the information, or communicating directly to the user's device using telephony, wireless communications, Internet, and so forth. In addition, in other embodiments, a single merchant may use a separate login for each type of product or service it promotes or other methods may be used to identify the merchant and its products such as creating a unique merchant identifier as well as unique product/service identifiers for each product or service.

2. Promotion Collection Process

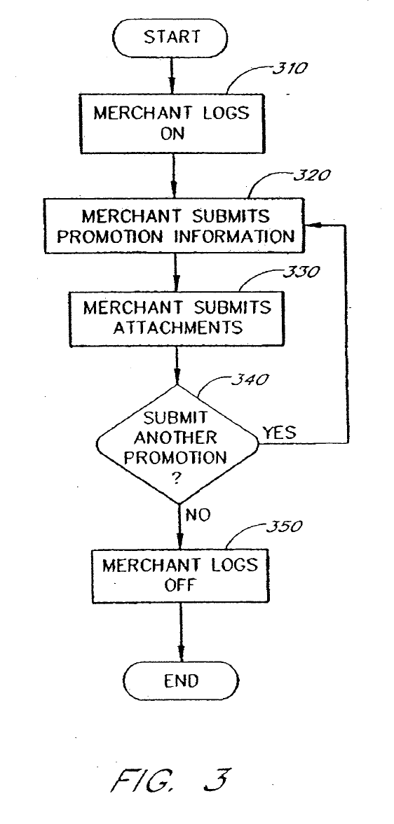

In one embodiment, the promotion collection process enables merchants to submit promotions for display via universal transaction managers or for direct target advertising. In one embodiment, the promotion collection process receives promotions from merchants on-line via the web site as illustrated in FIG. 3.

First, the merchant logs on using its unique login and secure password (block 310) as created in the merchant registration process (FIG. 2). Next, the merchant submits information about the promotion, such as, for example, the name of the promotion, the category of goods or services in which the promotion falls (e.g., sports, lodging, food, entertainment, airline etc.), the points available, the dates that the promotion is effective, the location of the promotion event, any specific restrictions, cost of the promotion, qualifying rules, and other information relating to the promotion (block 320). Third, the merchant may submit any additional files such as graphic files, audio files, video files, or other files associated with the presentation of the promotion (block 330). Finally, the merchant may submit another promotion (block 340) or log off the system (block 350).

FIG. 3 illustrates one embodiment of a promotion collection process and other embodiments may be used. For example, a merchant may submit or be assigned a unique identifier for each promotion. Further, the attachments may be submitted at a different time.

It is also recognized that in other embodiments, the merchant may submit information about the promotion using other methods of submission such as by email, filling out a paper questionnaire, faxing the information, wireless communications, etc.

3. Merchant Billing Process

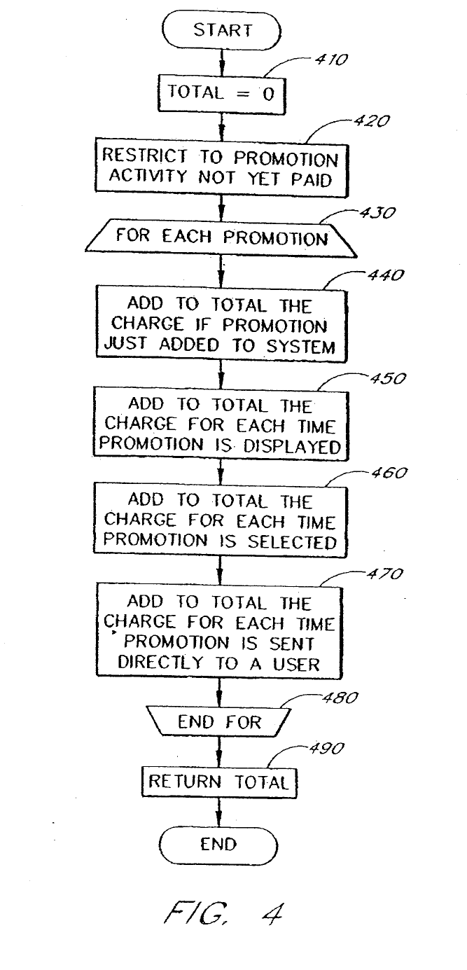

In one embodiment, the merchant billing process tracks when a merchant's promotions are displayed or sent to the user. In one embodiment, the merchant is billed for any activity in which the merchant's promotion is used by the system as illustrated in FIG. 4.

First, the total is initialized to zero (block 420). Next, the activity is restricted to activity for which the merchant has not yet paid (block 420) as to avoid duplicate billing. In other embodiments, the activity may be restricted to different activity (e.g., for activity not yet billed) or not restricted at all. Then, for each of the merchant's promotions (block 430), the merchant is charged for every time (i): the merchant adds a promotion to the system (block 440), (ii) one of the merchant's promotions is displayed on the web page as a direct advertisement or on the transaction manager agent (block 450), (iii) a user selects one of the merchant's promotions (block 460), (iv) one of the merchant's promotions is sent to a user (block 470), and/or (v) any other time a merchant's promotion is used (not shown). After all of the merchant's promotions within the restricted set have been traversed (block 480), the total is returned (block 490).

The merchant billing process may be implemented in a different manner. For example, a running total may be stored in the database and incrementally updated, such as, every hour, every day, upon merchant request, and so forth. Further, the total may be updated each time the merchant or a user performs an action that affects the total.

In other embodiments, different factors as well as any subset and/or combination of those described above may be considered when billing the merchant. In addition, certain activity may be weighed more heavily than other activity. For example, a merchant may be charged more or only for each time a user selects its promotion and less for each time a promotion is merely displayed in the user transaction manager. In addition, a merchant may receive a discount for submitting multiple promotions. The merchant billing process is preferably run for each merchant in the system. In an alternative embodiment, a fee could be charged for posting a promotion with no fees for display or use.

In one embodiment, merchants may log onto the system, view their current billing information and pay the bill. In addition, merchants may view their billing information by activity pertaining to a subset of users, an individual promotion, a subset of promotions, or all of its promotions. In addition, the merchant may limit the usage and the number of times the promotion can be selected by users. The merchant billing process may calculate each merchant's bill on a regular basis or dynamically each time the merchant wishes to view its current bill. Many alternatives are possible.

B. User Customization Module Processes

In one embodiment, the user customization module 154 includes a user registration process and user request process. The user customization module 154 may include other processes (not shown) such as, for example, a process for sending updates to users, a process for tracking user activity, and so forth.

1. User Registration Process

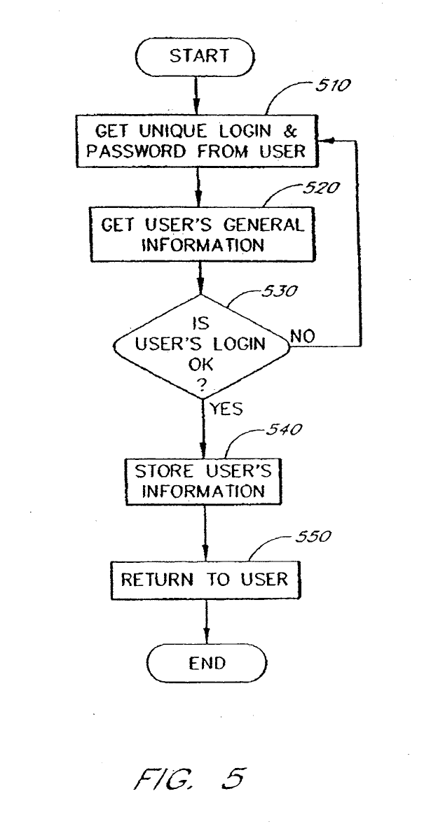

In one embodiment, the user registration process collects and manages information about the users that wish to use a universal transaction manager. The user registration process may permit users to designate their interest on-line via the web site as illustrated in FIG. 5.

First, the user may create a unique login and secure password (block 510). Next, the user may submit general information such as the user's name, mailing address, state, zip code, phone number, email address, gender, age as well as any other general information (block 520). Then, the user registration process verifies the login (block 530), stores the user's information (block 540), and returns to the user (block 550).

FIG. 5 illustrates one embodiment of a user registration process and other embodiments may be used. For example, the user's login may be verified immediately after the login/password is received. Further, the user may submit general information at a different time, and the user's information may be stored as soon as it is received.

It is recognized that in other embodiments, the user may submit information using other methods such as submission by email, filling out a paper questionnaire, faxing the information, and so forth. In addition, in other embodiments, the user may choose to bypass the login process.

2. User Request Process

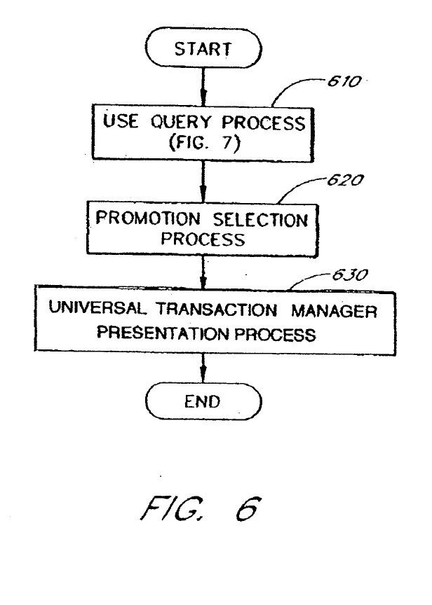

In one embodiment, the user request process presents the user with a custom universal transaction manager and permits the user to indicate which merchants, if any, may access the user's transaction manager and the user's requests. For example, a user may allow merchants to “bid” on the user's request. Preferably, as illustrated in FIG. 6, the user request process includes a user query process (block 610), a promotion selection process (block 620), and a transaction manager presentation process (block 630).

a. User Query Process

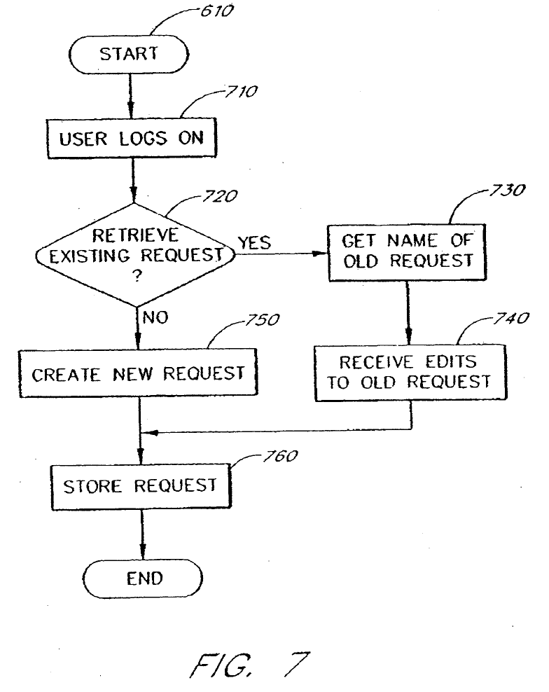

In one embodiment, the user query process queries the user to determine the user's interests as illustrated in FIG. 7. First, the user logs on using a unique login and secure password (block 710) as created in the user registration process (FIG. 5). It is recognized that in other embodiments, however, that the user may bypass the login. Next, the user may choose to create a new request or to retrieve an existing request (block 720). If the user retrieves an old request, then the user may enter the name or ID of the existing request (block 730) and edit the retrieved request (block 740) through edits such as altering the name, category, place, date, and/or event. For example, if the user has indicated that merchants may access the user's requests, merchants may have added promotions to the promotions database which will now appear on the user's universal transaction manager. Users may also, if requested by the user, receive email from merchants who view the user's transaction manager and want to provide a promotion. It is recognized that in other embodiments, the request may be defined by parameters other than or in addition to name, category, date, place and event. For example, the request may include price range, number of persons, preferred hotel, quality ratings (e.g., four stars), number of loyalty points, and so forth.

If the user chooses to create a new request, then the user may create a new request by entering a name or ID for the request and then designating the category, place, date, desired event, and/or other information as described above (block 750). The user preferably submits information via a form which includes fields, though other interface techniques or combinations thereof may be used such as radio buttons, checkboxes, drop down lists, and so forth. Finally, the process stores the results in the database collection 160 (block 760). In one embodiment, the user may elect to receive email when a relevant new promotion is added to the promotion database.

b. Promotion Selection Process

In one embodiment, the promotion selection process chooses promotions related to the user's designated interests. The promotion selection process may select promotions specific to the user's request (e.g., interest rate, pay off date, loyalty points, category, place, date, and/or event) that may be displayed in the universal transaction manager as well as promotions that relate, in general, to the user's interests. For example, if the user indicated an interest in “Golfing in Maui during the month of June 1999,” the promotion selection process may select a promotion for “50% off all green fees at the Maui Golf Course from June 6^{th} to June 12^{th}” as well as a coupon for “Free golf balls with every purchase” if the user makes a purchase using a specific credit card.

It is recognized that the promotion selection process may be implemented differently in other embodiments.

c. Transaction Manager Presentation Process

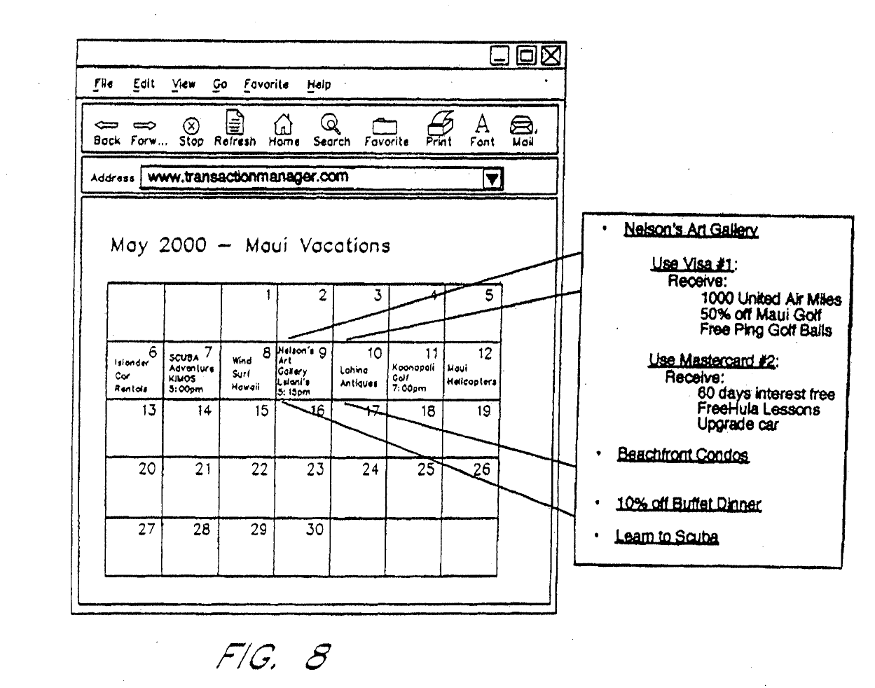

In one embodiment, the transaction manager presentation process displays promotions relating to the user's designated interests in a transaction manager format. For example, in each transaction manager credit account, a symbol or hyperlink may be shown such that the user may select the symbol or hyperlink and receive more detailed description of the available promotions. It is recognized that in other embodiments, the placement of the promotions or a link to the promotions on the transaction manager may be implemented differently using a check box, a pop-up window, or other graphical interface feature. FIG. 8 illustrates a sample universal transaction manager web page.

In one embodiment, the promotions may be color coded or emphasized using different fonts and/or graphics to enable the user to differentiate between merchants or to identify rankings of features such as price, date, time, or place.

In one embodiment, users and/or merchants may communicate with the universal transaction manager using standard interface techniques, such as, for example, a mouse, a touch screen, voice commands, a keyboard, a pen, and so forth. In addition, various commands may be available to the user and/or merchant through a variety of interface tools. For example, the user may be able to click on a promotion and be automatically connected to the merchant (e.g., via the merchant's web site, email, or telephone) to confirm information about the promotion or to make a purchase; a merchant may be able to click on a button that allows the merchant to look at the merchant's transaction manager of promotions, billing information, as well as other information.

Furthermore, it is recognized that the transaction manager may be implemented in a variety of languages as well as using a variety of transaction manager methodologies.

In one embodiment, the transaction manager presentation process displays promotions related to the user's designated interests in a single promotion format. For example, the transaction manager presentation process may send the user an interactive coupon for “15% off scuba equipment rental” with a link to the scuba company's web site in association with the use of a specific credit card. In another embodiment, the transaction manager presentation process displays a set of promotions related to the user's designated interest. The set of promotions may include a set of promotions related to Golf in one page under a tab marked “GOLF” and a set of coupons related to various restaurants in another page under a tab marked “DINING.” The transaction manager presentation process may also display, on a single page, a list of links to coupons related to Golf and a list of links to coupons related to Dining. Furthermore, promotions may be presented to the user through a variety of methods such as direct targeting of individual users or groups of users that have similar interests. This targeting may include promotions sent via email, promotions sent to a cellular phone, promotions sent to a personal digital assistant display, promotions sent via facsimile, and so forth.

### IV. Operation

In operation, the universal transaction manager system may be used to provide merchants with the ability to market their dynamically changing inventory of goods and services. In addition, users can designate goods and services of which they have an interest and be presented with promotions that match those interests.

For example, a user may be planning to travel to Maui, Hi. from May 6, 2000 to May 12, 2000 and is interested in promotions that pertain to car rental, scuba diving, wind surfing, dining, shopping, and tennis. The user may contact the universal transaction manager system using, for example, his cellular phone and request information, using voice commands, about the above areas specifying the dates of his travel. The system may then present the user with a display of the week of travel as well as promotions that match his interest. FIG. 8 illustrates a sample display that includes promotions for Golf, Scuba, Dining, Car rental, and Tennis for the dates of May 6 to May 12.

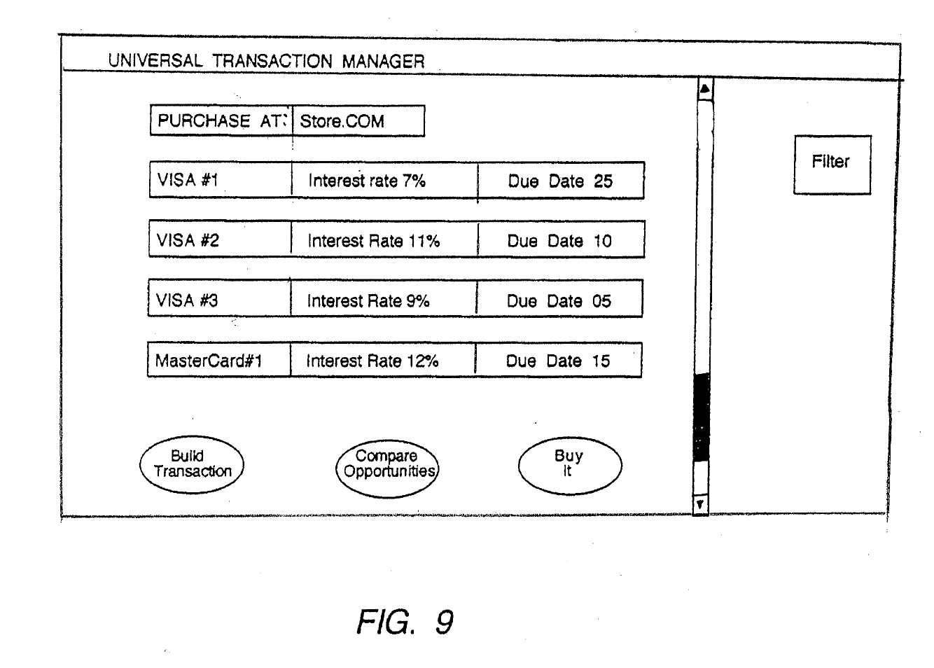

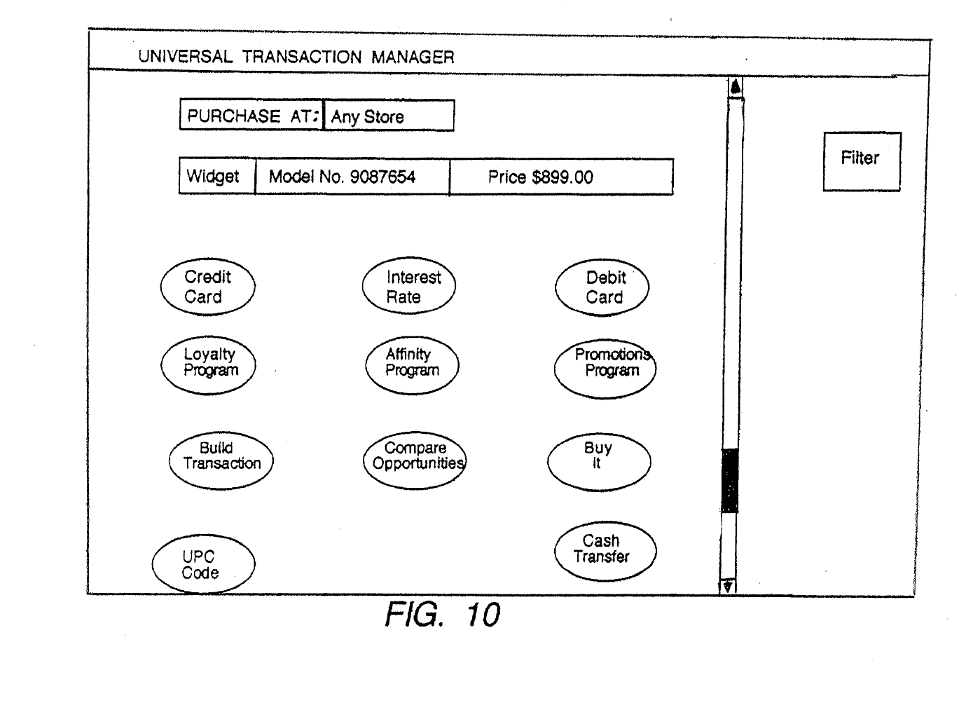

The filters depicted in FIG. 9 and FIG. 10 provide differential filters that enable the user to restrict the types of offers provided in the system in a variety of ways such as finely defining the precise requirements of the good or service desired by the user. In essence, the filter option permits the user to filter unwanted offers that do not match the user's exact requirements. Filter attributes may be configured to include and/or exclude almost anything a user desires.

For example, the user may have four credit lines each with different due dates when the bill must be paid in full. The user sets the customization module to execute the purchase transaction on the credit line with the most number of days prior to the account being due and payable. FIG. 9 illustrates a way in which users and/or purchasers may manage various credit cards used in a storefront. Perhaps the store (e.g., Safeway) is co-promoting with Visa or with a particular bank entity. The purchaser may reveal to the storefront various account information. Safeway may then suggest MasterCard #1 as a payment method to save money and earn additional opportunities (e.g., the filter reveals that the purchaser may collect United Air Miles). However, the purchaser may want to compare opportunities, build a transaction (e.g., various UPC's purchased Pepsi/Heinz 57), and finally buy it. The purchaser has the capability of analyzing each element that may affect the transaction. Moreover, the filter switch enables the purchaser access to his or her preferences.

The electronic device, where the user's universal transaction manager resides, presents the information on the credit lines prior to the purchase transaction through a visual display or by audible information to the user and/or the system could be set to automatically default to the desired preferences of the user and execute the purchase transaction automatically. In this aspect, the universal transaction manager module 150 may operate independently as an agent on behalf of the user.

FIG. 10 displays various elements that may affect the transaction's actual cost. Perhaps the user transaction manager suggests Visa #1 because of the long billing cycle or interest rate which was established by the user when creating his or her “rules.” Here, the user could override the system and manually compare other possibilities, such as, for example, co-promotions against the UPC of a product, air miles, and so forth.

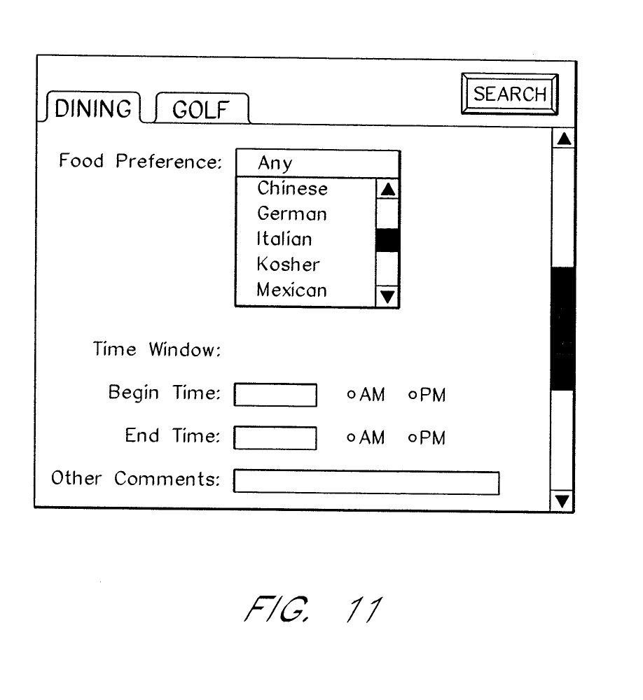

In addition, suppose the user is interested in finding out more information on the dining promotions, the user may select dining using a voice command and the user may be presented with a list of options that pertain to dining as illustrated in FIG. 11. By selecting Food Preference, the user may select from a variety of food features such as, for example, Chinese, Mexican, Italian, German, Vegetarian, Vegan, Unsalted, Kosher, Organic, No Preservatives, No MSG, and so forth. In addition, the user may elect a specific time window such as, for example, 6:00 am, 12:00 noon, or 5:30 p.m. Furthermore, the user may also select a preferred locations feature, such as, for example, Lahaina, Kihei, Al's Grill, The Steak House, Seafood Station, No Smoking, Smoking, Window, Near a specific address location (enter address), and so forth. Finally, the user may want to compare the opportunities based on the specific credit card that he will use in the purchasing (transaction) process.

The user may also utilize a map feature that presents the user with a map of the location of the service as well as other information. This information may include driving distance, travel time, photo of location, photo of building, sample menu, list of prices, dining ratings, and so forth.

After the user has selected his preferences, if any, the user may also purchase the merchant's goods and/or services. For example, if the user selects a 10% discount for a full buffet dinner at 5:30 p.m. on May 8, for a no smoking table at Lelani's, the user may then elect to pre-purchase the dinner. The user will then pay for the goods/services with the digital wallet feature included in the universal transaction manager using an electronic account, a credit card, a debit card, an ATM card, a direct debit code, loyalty/affinity points, and so forth.

In another example, a user may be planning a business party in Portland, Oreg. on Jun. 4, 2000 and may be looking for a caterer for the party. The user may contact the universal transaction manager system using, for example, his Palm Pilot and request information about caterers in Portland, Oreg. on Jun. 4, 2000. The universal transaction manager system may present the user with a set of promotions from various merchants. One merchant may offer a 20% discount for parties of 400 or more, and 10,000 airline mileage points with the use of a specific credit card in an interactive coupon that includes a web link to the merchant's web site and airline's site. Another promotion may include a video and audio commercial that runs on the user's Palm Pilot and that illustrates sample entrees in which the caterer specializes and may include a voice activated command at the end of the commercial that sends an email directly to the caterer with the user's email address and other contact information.

Finally, although a sample universal transaction manager display has been shown above, the display of a universal transaction manager is not necessary. Specifically, the universal transaction manager system may provide a simple agent service. In one embodiment, rather than a transaction manager display, a user may input desired activity and the date desired through entry fields, through a promotion presentation screen, or through a voice response system. In such an embodiment, the actual transaction manager grid is not required. In other words, in an embodiment without the transaction manager grid, the transaction manager system may operate as an agent for the user with the user inputting the desired activity, location and date, and the transaction manager system providing or allowing merchants and service providers to provide options directly to the user with a presentation window rather than the transaction manager grid. Accordingly, the present invention is not limited to the use of a transaction manager grid interface. Voice and other presentation interfaces may provide the same matching of offers for goods and services with desired dates for such goods or services of the user.

### V. Additional Embodiments

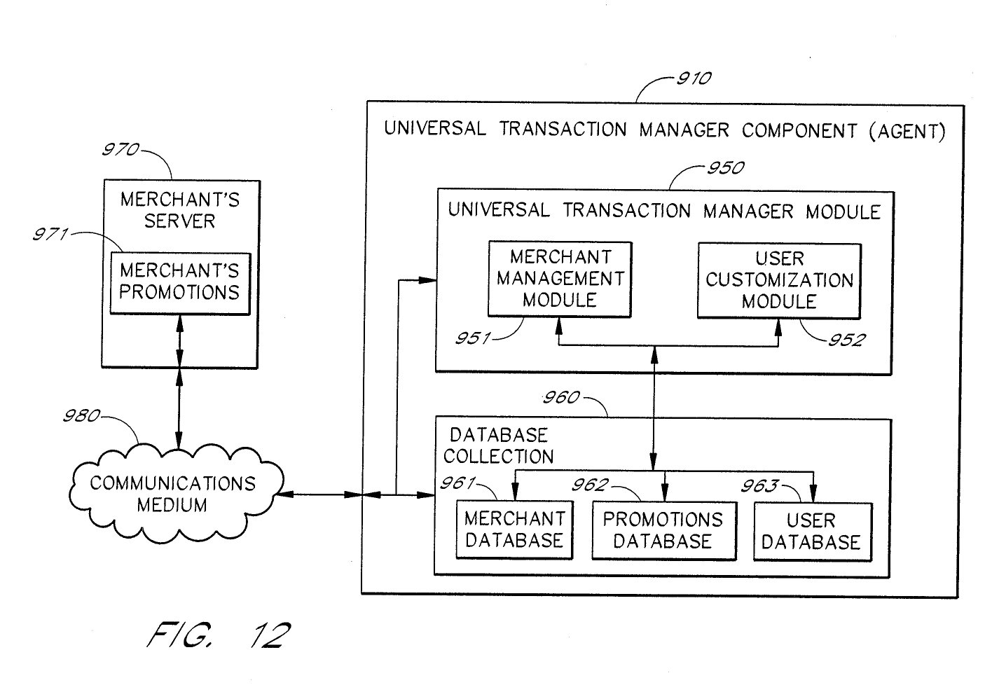

In other embodiments, the universal transaction manager may operate as a standalone agent as shown in FIG. 12. The agent may be embedded in a variety of devices or may be transmitted as an application, such as a Java Applet (application) through the communications medium 130. The universal transaction manager component 910 illustrated in FIG. 12 includes a universal transaction manager module 950, and a database collection 960.

The universal transaction manager component 910 may interact with other components, interfaces, and/or protocols (not shown). For example, the universal transaction manager component 910 may communicate with a merchant's promotions database in order to synchronize with other promotions which are available based on the use of credit cards, debit cards, ATM, loyalty points, affinity points, and/or discounts. This synchronization may be one way or two way synchronization wherein the universal transaction manager module 950 only receives events, only sends events, or receives and sends events. In another example, the universal transaction manager may synchronize with a cellular phone to allow the user to receive phone calls about a variety of promotions and/or to automatically call merchants to obtain more information about the promotions. In another example, the universal transaction manager might be configured to acquire discounts in a certain location, such as within a specified zip code. The user may activate a GPS (global positioning) interface with the universal transaction manager to send opportunities which match the user's interest based upon the user's specific location. By restricting selections, the universal transaction manager may also become a filter preventing invasion of the user's privacy by unwanted advertisers.

In one embodiment, the customer may play a game via a rules-based module or the universal transaction manager. For example, as part of a travel package, the customer may be invited to participate in a game through merchants in Maui. Manufacturers co-promote through the customer's personal universal transaction manager and may apply new “rules” to drive traffic through stores and to increase purchasing. A travel agent may ask the customer how the customer wants to play the game (i.e. what are your rules?). The customer may reply, “through my cell phone, use SIC codes for the stores and UPC's for the products.” The travel agent may respond, “if you confirm every store SIC code through your system (UTM), we will give you 10,000 air miles or $50.00 to spend loaded into your credit account at completion.” In other examples, the customer may be competing with other customers to “win the game” and to thus win various promotions.

In various embodiments, the customer may verify his or her identity using various biometric techniques such as DNA verification, finger print recognition, voice recognition, or eye scanning (e.g., iris print). For example, a customer may be on vacation in Fiji and go to the local beach bar to order a refreshing lemonade at the beach bar's point of sale (“POS”) devices. The customer may provide an imprint of his or her fingerprint to the POS device's fingerprint recognition module. The customer's fingerprint is confirmed via the POS device which communicates with the customer's universal transaction manager over a network. Based upon the customer's rules, the transaction is made with the user's credit card #1 which gives the best exchange rate, and the transaction is complete.

It is recognized that a variety of biometric devices may be used and that they could be used for multiple account management. For example, a customer may place a call from a telephone or cellular phone and identify the POS device at the customer's location. The customer may then recite (e.g., via voice or key entry) the customer's password. The customer's universal transaction manager may then verify the password and complete the transaction.

In other embodiments, the customer may insert a smart card into a device such as the customer's personal computer, personal digital assistant, kiosk cellular phone, telephone automobile, or other device. The customer's universal transaction manager, which resides on the device or may be accessed remotely, is then contacted. The universal transaction manager may then synchronize immediately or at a later time such that account information or promotion information may be downloaded onto or uploaded from the smart card. The smart card may also include merchant information from one or more merchants.

In one example, a customer may insert a smart card into the customer's personal computer every night. At 6:00 a.m., the personal computer may automatically connect with the customer's universal transaction manager, and the universal transaction manager may embed into the smart card the credit/debit account with the best advantage based upon the customer's rules and the available merchant promotions. The customer may then put the smart card in his or her wallet and use the smart card for purchases knowing the smart card includes information about which account currently has the best promotions.

In one embodiment, the universal transaction manager module acts as an agent communicating with other universal transaction manager module(s) 150 to coordinate opportunities. In one example, a consumer A has a digital device which is embedded with the universal transaction manager module 150. Another consumer B, in close proximity, also has a digital device embedded with the universal transaction manager module 150 and thus has access to a universal transaction manager agent. Consumer A might desire to update the promotions and or loyalty point opportunities from consumer B who has just been on a communications network. By exchanging the information between devices either by a port (infrared, plug, Universal Serial Bus connection, etc.), keypad entry, voice, or other interface device, consumer A would be able to have current opportunities which consumer B had already updated without obtaining access to a network communication system such as telephone, microwave, or Internet.

In another embodiment, a transaction may involve a method for providing wire transfers of currency either within one country and/or from country to country. The transaction involves drawing on currency reserves and/or credit reserves which originate in one country and using arbitrage calculations similar to banks to maximize the final amount of currency available when transferred to another location within the originating country or another country. In one embodiment, the user customization module 154 is further configured to make a series of currency exchanges between a plurality of countries to insure that the greatest amount of currency is made available at the final country for which the original currency transfer was destined.

In one embodiment, the universal transaction manager acts as a unified billing system so that payments for established accounts may be executed either by manual configuration of the universal transaction manager by the user or automatically by the transaction manager as configured by the user's preferences. In one embodiment, the transaction manager may combine all the available opportunities including credit, debit, loyalty points and promotions to effect payment to a specified account. The unified billing system may also include an alert payment notification which could be executed from a variety of communication systems including email, telephone and paging for example.

### VI. Conclusion

While certain embodiments of the invention have been described, these embodiments have been presented by way of example only and are not intended to limit the scope of the present invention. Other embodiments are also within the scope of this invention. For example, although the embodiments described herein employ on-line registration, other methods for registration can be used. Accordingly, the breadth and scope of the present invention should be defined in accordance with the following claims and their equivalents.

1-11. (canceled)

12. A computer-readable medium including executable instructions adapted to perform a method for managing a plurality of custom-selected promotions, the method comprising:
requesting a plurality of promotions relating to a plurality of merchants;
submitting user information relating to at least one user;
receiving a set of promotions, wherein the set corresponds to at least a subset of the user information and at least one of the plurality of merchants; and
selecting at least one of the set of promotions, wherein the selection is based at least in part on comparing the set of promotions to one or more user accounts configured to transfer funds in a commercial transaction.

13. The computer-readable medium of claim 12, wherein the user information includes one or more user preferences selected from the group comprising interests, hobbies, desired products, desired services, upcoming travel plans, and preferred merchants.

14. The computer-readable medium of claim 13, wherein the user information further includes account information for the one or more user accounts.

15. The computer-readable medium of claim 14, wherein the account information comprises one or more items of information selected from the group comprising credit card account information, debit card account information, on-line payment information, and bank account information.

16. A system for facilitating the matching of at least one promotion with at least one user, the system comprising:
a merchant management module configured to manage, via an electronic communications medium, at least one promotion that corresponds to at least one of a plurality of merchants;
a user module configured to manage preferences, wherein the user module is further configured to manage a plurality of user accounts for transferring funds; and a transaction module configured to present information about the at least one promotion to at least one user wherein the promotion relates to preferences that correspond to the user, wherein the transaction module is further configured to select at least one of the plurality of user accounts for use with the at least one promotion.

17. A computer-readable medium including executable instructions adapted to perform a method for managing promotions, the method comprising:
receiving a promotion relating to a merchant;
selecting a user account from a plurality of user accounts to use for a commercial transaction with the merchant, wherein the selection is based at least in part on the promotion.

18. The computer-readable medium of claim 17, wherein the promotion comprises a program selected from the group comprising discounts, coupons, free services, free goods, sweepstakes, interactive games, credit card rebates, and charitable donations.

19. The computer-readable medium of claim 17, wherein the selection is further based on one or more factor selected from the group comprising a date of the transaction, an amount of the transaction, and an identity of the merchant.

20. The computer-readable medium of claim 17, wherein the selection is further based on account information selected from the group comprising a credit line, a date when the account is to be paid, and a second promotion offered by the account.
